(19) United States
(12) Patent Application Publication
(10) Pub. No.: US 2005/0087127 A1
(43) Pub. Date: Apr. 28, 2005

(54) Apparatus for forming an organic layer and method of forming an organic layer

(75) Inventors: Yong-Kuk Yun, Suwon-si (KR); Baek-Kyun Jeon, Yongin-si (KR); Dae-Ho Choo, Yongin-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 10/779,524

(22) Filed: Feb. 13, 2004

(30) Foreign Application Priority Data
Oct. 27, 2003 (KR) 2003-75144

(51) Int. Cl. B05C 5/00

(52) U.S. Cl. 118/300; 118/313

(57) ABSTRACT

An apparatus for forming an organic layer on a substrate includes a spraying device, the spraying device including a plurality of head units each formed in a corresponding row. Each head unit is shifted a horizontal distance from a previous head unit.

### BACKGROUND

1. Technical Field

The present disclosure relates to an apparatus and a method for manufacturing an organic layer, and more particularly to an apparatus and a method for manufacturing an organic layer with a uniform thickness.

2. Disclosure of Related Art

A liquid crystal display apparatus, which is one type of display apparatus, has many advantages, such as low weight, small thickness, low power consumption and low driving voltage. Thus, liquid crystal display apparatuses have many applications, including mobile phones and wall mounted television sets.

A conventional liquid crystal display apparatus includes a liquid crystal display panel and a backlight assembly. The liquid crystal display panel includes a thin film transistor substrate, a color filter substrate and a liquid crystal layer interposed between the thin film transistor substrate and the color filter substrate. The thin film transistor substrate includes a thin film transistor for switching a pixel, and a pixel electrode. The thin film transistor substrate further includes a photoresist layer for patterning and an insulation layer for insulating a metal layer. The color filter substrate includes a common electrode disposed opposite the pixel electrode, an over-coating layer for leveling and an organic layer for forming a black matrix. The backlight assembly provides the liquid crystal display panel with light.

Generally, the organic layer of the color filter substrate is formed via a flexography method. According to the flexography method, an anilox roll and a doctor blade make contact with each other while the anilox roll rotates so that a measured amount of organic material is applied to the anilox roll. The anilox roll is then placed in contact with a resin plate that is attached to a plate cylinder so that the organic material adheres to the resin plate. When the plate cylinder rotates, the organic material is printed on a substrate to form an organic layer.

As the size of display regions of liquid crystal display apparatuses increase, the size of mother substrates for liquid crystal display panels also increase. In some applications, the length of mother substrates has increased to greater than 2 m.

Also, to reduce manufacturing cost, a large number of thin film transistor substrates or color filter substrates are formed from the same mother substrate.

As the size and the number of thin film transistor substrates and color filter substrates formed of a same mother substrate increase, the size and the number of resin plates corresponding to the thin film transistor substrates and the color filter substrates also increase. Further, a larger plate cylinder is required to accommodate the increased size and number of resin plates.

However, manufacturing large resin plates and plate cylinders has proven to be very difficult. Thus, as a substitute for the flexography method, an apparatus for manufacturing the organic layer by spraying organic material has been developed.

It is desirable to minimize the interval between organic material drops to achieve uniformity of the organic layer. Manufacturing the organic layer by spraying organic material results in large intervals between dropped organic material. Thus, the organic material must be spread on the substrate to achieve a more uniform organic layer, which results in the overall process having a high dependence on a surface state of the substrate.

FIG. 1A is a schematic view showing drop patterns formed according to a conventional spraying method, and FIG. 1B is a schematic view showing drop patterns formed according to a conventional flexography method.

As shown in FIGS. 1A and 1B, an interval between the dropped organic material formed according to a conventional spraying method is about 130 μm, and an interval between the dropped organic material formed according to a conventional flexography method is about 20 μm.

That is, the interval between the dropped organic material formed by the spraying method is greater than six times the interval between the dropped organic material formed by the flexography method. Thus, the conventional spraying method requires more than one hour of UV cleaning to decrease dependence on surface state of the substrate.

Further, organic material used in the conventional spraying method has a lower viscosity than organic material that is used in the flexography method, so that the conventional spraying method forms a larger area of organic material at the edge region of the substrate. Thus, the drying speed at the edge region is higher than the drying speed at other regions of the substrate, so that the organic material is driven to the edge region. This causes the conventional spraying method to form an organic layer at the edge region of the substrate that is thicker than the organic layer at other regions of the substrate.

Other methods, such as the plasma ashing method, produce deteriorated uniformity of the organic layer in comparison with the flexography method.

As discussed above, it is difficult to use the conventional flexography method to form an organic layer on a large mother substrate, and the conventional spraying method produces organic layers having deteriorated uniformity due to large intervals between droplets and the relatively low viscosity of sprayed organic material. Accordingly, there is a need for an apparatus and method that can produce a uniform organic layer on a large mother substrate.

### SUMMARY OF THE INVENTION

An apparatus for forming an organic layer on a substrate according to an exemplary embodiment of the invention includes a spraying device, the spraying device including at least one head unit. A plurality of heads are alternately disposed in first and second sub rows to form a zigzag pattern on the at least one head unit.

In at least one exemplary embodiment of the invention, the least one head unit includes a plurality of head units each formed in a corresponding row, and each head unit is shifted a horizontal distance from a previous head unit.

In another exemplary embodiment of the invention, the spraying device forms an angle with respect to a side of the substrate.

In another exemplary embodiment of the invention, the apparatus for forming an organic layer further includes a transferring device that transfers the stage in a first printing direction, a second printing direction that is opposite to the first printing direction, and a third direction that is substantially perpendicular to the first printing direction.

In still another exemplary embodiment of the invention, the spraying device moves in a first printing direction, a second printing direction that is opposite to the first printing direction, and a third direction that is substantially perpendicular to the first printing direction.

A method of forming an organic layer on a substrate supported by a stage according to an embodiment of the invention includes transferring the stage in a first printing direction while a spraying device sprays organic material onto the substrate, transferring the stage in a non-printing direction that is substantially perpendicular to the first printing direction, and transferring the stage in a second printing direction that is opposite to the first printing direction while the spraying device sprays organic material onto the substrate.

A method of forming an organic layer on a substrate according to another embodiment of the invention includes moving a spraying device in a first printing direction while the spraying device sprays organic material on the substrate, moving the spraying device in a non-printing direction that is substantially perpendicular to the first printing direction, and moving the spraying device in a second printing direction that is opposite to the first printing direction while the spraying device sprays organic material onto the substrate.

### BRIEF DESCRIPTION OF THE DRAWINGS

The present invention will become more apparent by describing in detail exemplary embodiments thereof with reference to the attached drawings in which:

FIG. 1A is a schematic view showing drop patterns formed by a conventional spraying method;

FIG. 1B is a schematic view showing drop patterns formed by a conventional flexography method;

FIG. 2 is a schematic view showing an apparatus for manufacturing an organic layer according to an exemplary embodiment of the present invention;

FIG. 3 is a schematic view showing a spraying device of FIG. 2;

FIG. 4 is plan view showing a head of FIG. 3;

FIG. 5 is a cross-sectional view showing a head of FIG. 3;

FIG. 6 is a schematic view showing drop patterns of an organic material sprayed via spraying nozzle of first to n-th head units according to an embodiment of the present invention;

FIG. 7 is a schematic view showing an apparatus for manufacturing an organic layer according to another exemplary embodiment of the present invention;

FIG. 8 is a schematic view showing an apparatus for manufacturing an organic layer according to another exemplary embodiment of the present invention;

FIG. 9 is a plan view of the apparatus for manufacturing an organic layer shown in FIG. 8;

FIG. 10 is a schematic view showing drop patterns sprayed by an apparatus for manufacturing an organic layer according to an exemplary embodiment of the present invention;

FIG. 11 is a flow chart of a method of forming an organic layer according to an exemplary embodiment of the present invention;

FIG. 12 is a schematic plan view of an apparatus for manufacturing an organic layer according to another exemplary embodiment of the present invention; and

FIG. 13 is a flow chart of a method of forming an organic layer according to another exemplary embodiment of the present invention.

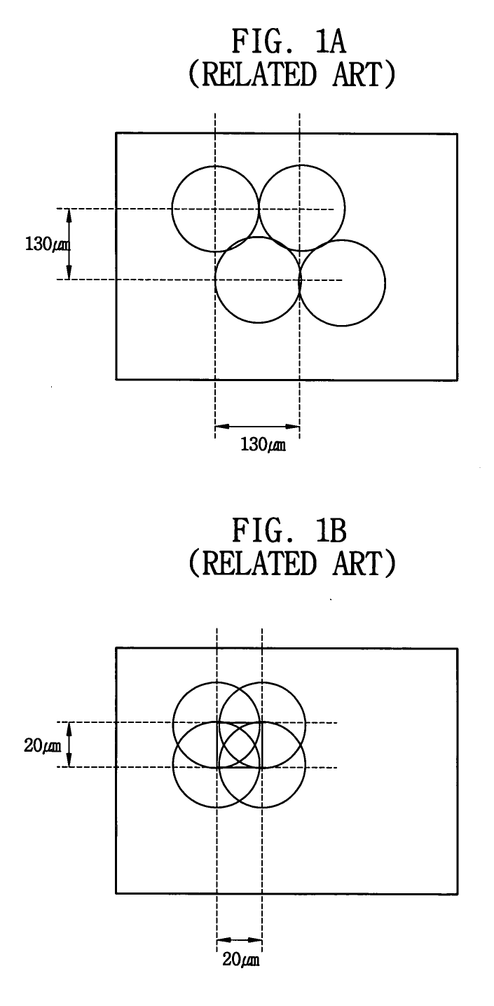

### DESCRIPTION OF PREFERRED EMBODIMENTS

Hereinafter the preferred embodiment of the present invention will be described in detail with reference to the accompanying drawings.

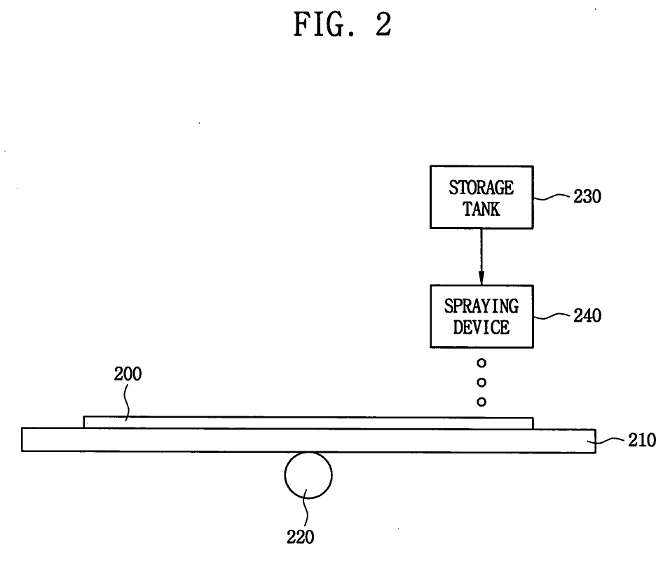

FIG. 2 is a schematic view showing an apparatus for manufacturing an organic layer according to an exemplary embodiment of the present invention.

Referring to FIG. 2, an apparatus 1 for manufacturing an organic layer includes a stage 210, a transferring device 220, a storage tank 230 and a spraying device 240. A mother substrate 200 is disposed on the stage 210. The transferring device 220 transfers the stage 210 in a printing direction. The storage tank 230 stores organic material. The spraying device 240 sprays the organic material on the mother substrate 200 to form an organic layer.

The viscosity of the organic material stored in the storage tank 230 is in a range of about 8 cP to about 12 cP.

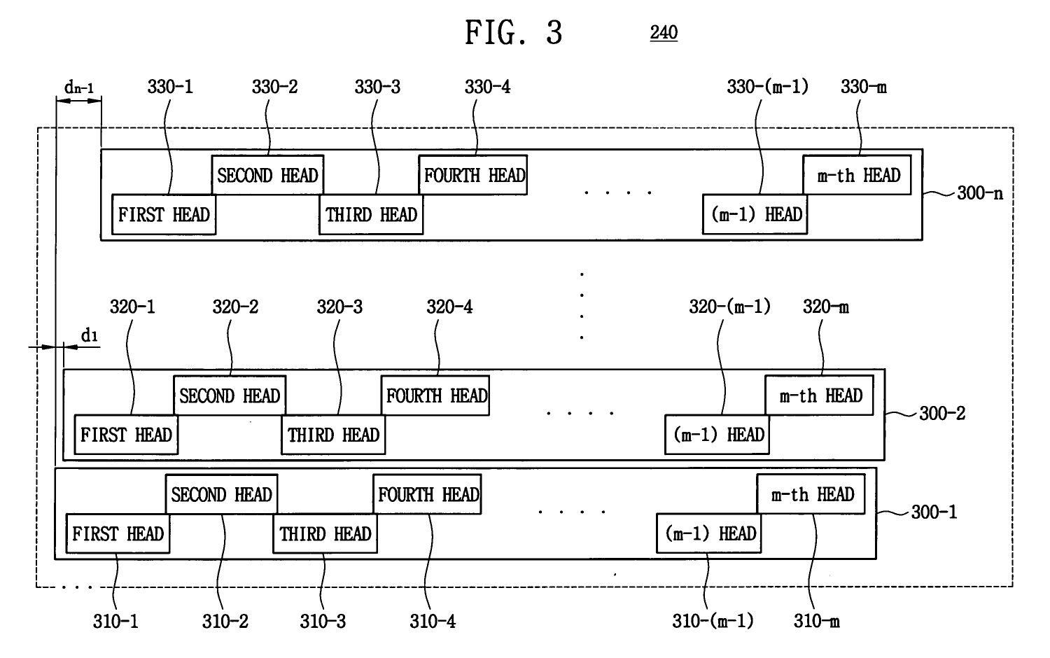

FIG. 3 is a schematic view showing a spraying device of FIG. 2.

Referring to FIGS. 2 and 3, the spraying device 240 includes first to n-th head units 300-1 to 300-n for spraying organic material provided from the storage tank 230 to a thin film transistor substrate region and a color filter substrate region of the mother substrate 200. The first to n-th head units 300-1 to 300-n are formed in first to n-th rows, respectively.

The first head unit 300-1 includes first to m-th heads 310-1 to 310-m. The number of heads ‘m’ is determined by the size of the mother substrate 200. The size of each head is about 70 mm. As the mother substrate becomes larger, the number of required heads increases.

Odd numbered heads 310-1, 310-3, . . . , 310-(m−1) are disposed in a first sub row, and even numbered heads 310-2, 310-2, . . . , 310-m are disposed in a second sub row that is substantially in parallel with the first sub row.

The distance between the neighboring odd numbered heads 310-1, 310-3, . . . , 310-(m−1) is smaller than the size of each head, and is substantially the same as the distance between the neighboring even numbered heads 310-2, 310-4, . . . , 310-m. The odd numbered heads 310-1, 310-3, . . . , 310-(m−1) and the even numbered heads 310-2, 310-4, . . . , 310-m are arranged in a zigzag form, so that the odd numbered heads 310-1, 310-3, . . . , 310-(m−1) overlap with the even numbered heads 310-2, 310-4, . . . , 310-m.

The second to n-th head units 300-2 to 300-n have substantially the same structure as the first head unit 300-1. That is, the second head unit 300-2 includes first to m-th heads 320-1, 320-2, . . . , 320-m, and the n-th head unit 300-n includes first to m-th heads 330-1, 330-2, . . . , 330-m. The first to m-th heads 320-1, 320-2, . . . , 320-m of the second head unit 300-2, and the first to m-th heads 330-1, 330-2, . . . 330-m of the n-th head unit 300-n have the same structure as the first to m-th heads 310-1, 310-2, . . . , 310-m of the first head unit 300-1.

Hereinafter, a structure of the first head 310-1 of the first head unit 300-1 will be explained in detail.

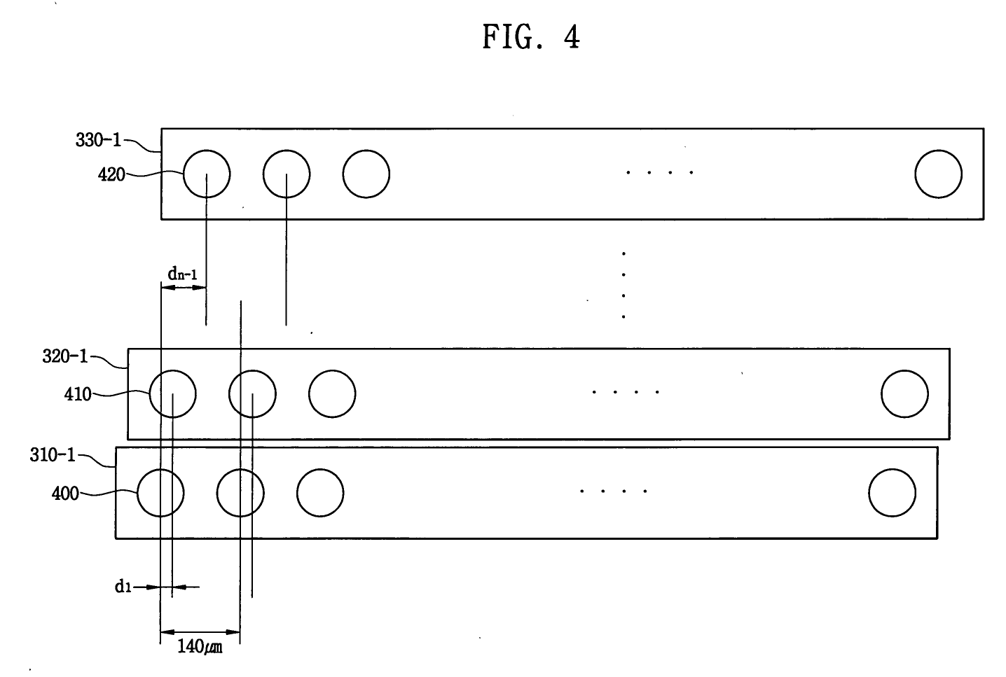

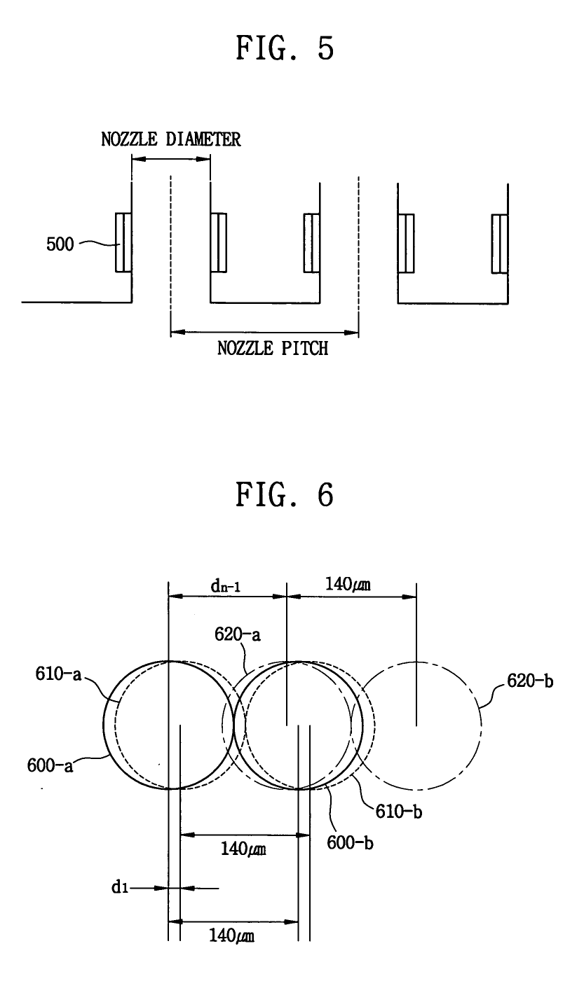

FIG. 4 is plan view showing a head of FIG. 3, and FIG. 5 is a cross-sectional view showing a head of FIG. 3.

Referring to FIG. 4, the first head 310-1 of the first head unit 300-1 includes a plurality of spraying nozzles 400 for spraying organic material. The spraying nozzles 400 are arranged in a line, and a pitch (or distance) between the neighboring spraying nozzles 400 is in a range of about 10 μm to about 500 μm, and is preferably about 140 μm.

Referring to FIG. 5, a piezoelectric element 500 is formed at an inner wall of the spraying nozzle 400. When electricity is applied to the piezoelectric element 500, the piezoelectric element 500 expands, so that the piezoelectric element 500 narrows the diameter of the nozzle 400 to control an amount of sprayed organic material.

In the present embodiment of the invention, the amount of the organic material is controlled, for example, by the piezoelectric element. However, a bubble jet spraying method or a thermal jet spraying method may be used to control the amount of the organic material.

Second to m-th heads 310-2 to 310-m of the first head unit 300-1 have substantially the same structure as the first head 310-1. Further, the heads of second to n-th head units 300-2 to 300-n have the same structure as that disclosed in FIGS. 4 and 5.

Referring again to FIGS. 3 and 4, the first to n-th head units 300-1 to 300-n are shifted in sequence. In detail, the second head unit 300-2 is shifted by a first distance d₁ with reference to the first head unit 300-1. Thus, when each neighboring head is shifted by the first distance d1, the n-th head unit 300-n is shifted by (n−1) x d₁, represented by an (n−1)-th distance dₙ₋₁, with reference to the first head unit 300-1.

The first to n-th head units 300-1 to 300-n are each shifted with respect to their neighboring head units, so that the first head 320-1 of the second head unit 300-2 is shifted by the first distance d, with respect to the first head 310-1 of the first head unit 300-1. The first head 330-1 of the n-th head unit 300-n is shifted by the (n−1)-th distance dₙ₋₁ with reference to the first head 310-1 of the first head unit 300-1. The (n−1)-th distance dₙ₋₁ is smaller than the pitch between the spraying nozzles.

Thus, droplets of the organic material sprayed via the first to n-th head units 300-1 to 300-n overlap with each other, so that a distance between the droplets is smaller than the pitch between the spraying nozzles.

When the first to m-th heads are arranged in a single row (or in a line), the droplet may be blocked via a neighboring head, thus producing a non-uniform distance between the droplets. Thus, the first to m-th heads disposed in each of the first to n-th head units 300-1 to 300-n are alternately disposed in first and second sub rows to form the zigzag form, so that a uniform distance is maintained between the droplets of the organic material.

Hereinafter, an operation of the apparatus for manufacturing an organic layer according to an embodiment of the invention will be explained.

Referring again to FIG. 2, the storage tank 230 stores organic material, and the storage tank 230 provides the spraying device 240 with the organic material. The organic material used with an apparatus according to various exemplary embodiments of the present invention has a lower viscosity than the organic material used with a conventional resin plate.

TABLE 1

| | | | Organic Material | |
|---|---|---|---|---|
| | Conventional | | Used With Embodiments | |
| | Organic Material | | of the Present Invention | |
| Viscosity | 25 | cP | 8˜12 | cP |
| Density of solid contents | 5 | wt % | 2.5 | wt % |
| Surface tension | 42.8 | dyn/cm | 39.3 | dyn/cm |

As shown in table 1, t the organic material used with embodiments of the invention has a viscosity ranging from about 8 cP to about 12 cP so that it can be sprayed via the spraying nozzle. When the viscosity is higher than 12 cP, the organic material cannot be properly sprayed. Optimum viscosity of the organic material is about 8 cP.

The first to n-th head units 300-1 to 300-n of the spraying device 240 spray the organic material on to the mother substrate 200. The second to n-th head units 300-2 to 300-n are shifted gradually by the first distance d₁ to dₙ₋₁, so that the spraying nozzles are also shifted.

Thus, droplets of the organic material displayed via the spraying nozzle overlap with each other.

FIG. 6 is a schematic view showing drop patterns of an organic material sprayed via spraying nozzle of first to n-th head units according to an embodiment of the present invention.

Referring to FIG. 6, first droplets 600-a and 600-b sprayed via a spraying nozzle 400 of a first head unit 300-1, second droplets 610-a and 610-b sprayed via a spraying nozzle 410 of a second head unit 300-2, and n-th droplets 620-a and 620-b sprayed via a spraying nozzle 420 of an n-th head unit 300-n overlap with each other.

In detail, the second droplets 610-a and 610-b sprayed via the spraying nozzle 410 of the second head unit 300-2 is shifted by the first distance d₁ with respect to the first droplets 600-a and 600-b sprayed via the spraying nozzle 400 of the first head unit 300-1.

Likewise, the n-th droplets 620-a and 620-b sprayed via the spraying nozzle 420 of the n-th head unit 300-n is shifted by the (n−1)-th distance dₙ₋₁ with respect to the first droplets 600-a and 600-b sprayed via the spraying nozzle 400 of the first head unit 300-1.

Thus, droplets of the organic material sprayed via the first to n-th head units 300-1 to 300-n overlap one another.

When the pitch between the nozzles is 140 μm, and ten head units are shifted by a same distance, a distance between the droplets may be reduced to 14 μm.

As described above, an apparatus for manufacturing an organic layer according to an embodiment of the invention forms a distance between droplets that may be shorter than that produced by the conventional flexography method.

Thus, forming an organic layer is not as sensitive to the status of the mother substrate. Therefore, a contact angle with respect to a surface of the mother substrate may be no more than 4°, even when a normal 70-second cleaning is performed. When the contact angle is no more than 4°, the organic layer is formed to have a uniform thickness.

Further, droplets sprayed via the spraying nozzles of the first to n-th head units 300-1 to 300-n overlap one another, so that drying speed of the organic material is lowered to prohibit the organic material from being driven to edge portions of the mother substrate.

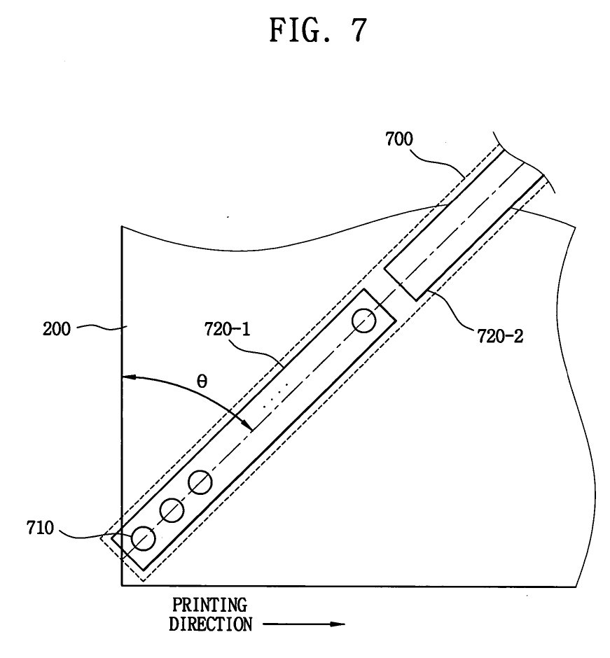

FIG. 7 is a schematic view showing an apparatus for manufacturing an organic layer according to another exemplary embodiment of the present invention. The apparatus for manufacturing an organic layer according to the present embodiment is the same as the previous embodiment except for the spraying device. Thus, the same reference numerals will be used to refer to the same or like parts as those described in the previous embodiment and any further explanation will be omitted.

Referring to FIG. 7, an apparatus for manufacturing an organic layer according to the present invention includes a spraying device 700, such that the spraying device 700 forms an angle θ with respect to a side of a mother substrate 200, wherein the angle θ is in the range from about ±0° to about ±89°.

The spraying device 700 includes first to m-th heads 720-1 to 720-m. Each head 720-1 to 720-m includes a plurality of spraying nozzles 710. Further, the spraying device 700 may include a plurality of head units arranged as shown in the previous exemplary embodiment of the present invention.

The spraying device 700 is inclined with respect to the side of the mother substrate 200, so that a distance between the droplets sprayed by the spraying nozzle 710 is further reduced, even when the pitch of the spraying nozzle 710 of the first to m-th heads 720-1 to 720-m is the same as in the previous exemplary embodiment of the present invention.

That is, when the spraying device 700 is inclined with respect to the side of the mother substrate 200 by 450 and the pitch of the spraying nozzle 710 is 140 μm, a distance between the droplets sprayed via the spraying nozzle 710 is about 9.9 μm.

Thus, the apparatus for manufacturing an organic layer according to the present embodiment may reduce the distance between the droplets as in the previous exemplary embodiment, even though the apparatus for manufacturing an organic layer of the present embodiment has a smaller number of head units than the apparatus for manufacturing an organic layer of the previous exemplary embodiment.

Further, when the apparatus for manufacturing an organic layer according to the present embodiment includes first to m-th head units 720-1 to 720-m as in the previous exemplary embodiment, the distance formed between the droplets is less than that produced in the previous exemplary embodiment.

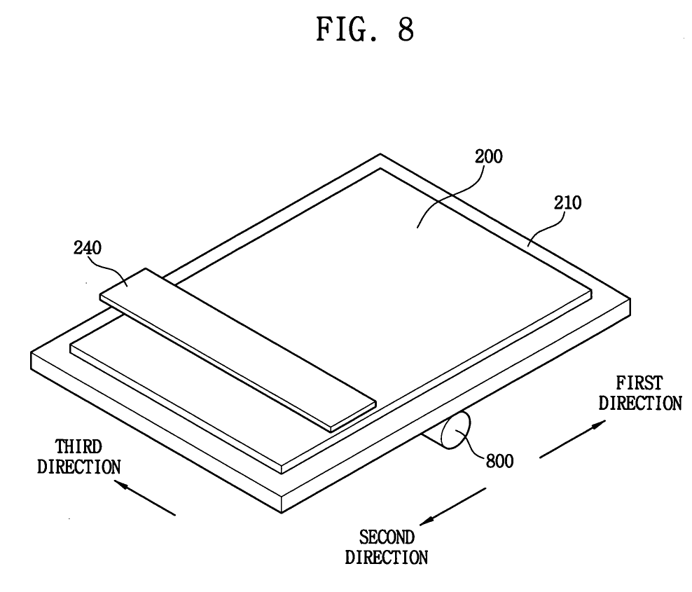

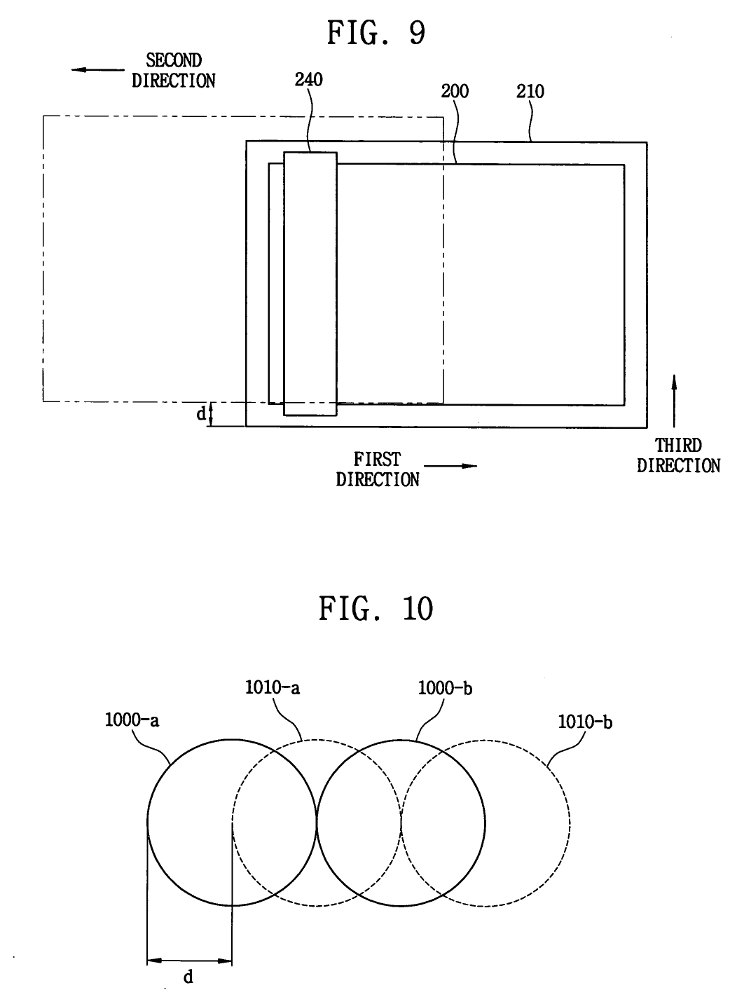

FIG. 8 is a schematic view showing an apparatus for manufacturing an organic layer according to another exemplary embodiment of the present invention, and FIG. 9 is a plan view showing the apparatus for manufacturing an organic layer of FIG. 8. The apparatus for manufacturing an organic layer according to the present embodiment is the same as previous embodiments of the present invention except for the transferring device. Thus, the same reference numerals will be used to refer to the same or like parts as those described in previous embodiments and any further explanation will be omitted.

Referring to FIGS. 8 and 9, an apparatus for manufacturing an organic layer according to the present exemplary embodiment of the invention includes a transferring device 800. The transferring device 800 transfers a stage 210 and a mother substrate 200 disposed on the stage 210 in a first direction, a third direction that is substantially perpendicular to the first direction, and a second direction that is opposite to the first direction.

In detail, the transferring device 800 transfers the stage 210 in the first direction, while a spraying device 240 that is fixed sprays an organic material toward the mother substrate 200. When a first end of the mother substrate 200 reaches the spraying device 240, the spraying device 240 stops spraying. Then, the transferring device 800 shifts the stage 210 in the third direction that is substantially perpendicular to the first direction by a predetermined distance ‘d’. Then, the transferring device 800 transfers the stage 210 in the second direction that is opposite to the first direction, while the spraying device 240 sprays the organic material toward the mother substrate 200. When a second end of the mother substrate 200, which is opposite to the first end, reaches the spraying device 240, the spraying device 240 stops spraying. Thus, droplets of the organic material sprayed on the mother substrate overlap one another.

FIG. 10 is a schematic view showing drop patterns sprayed by an apparatus of manufacturing an organic layer according to the present exemplary embodiment of the invention.

Referring to FIGS. 9 and 10, first droplets 1000-a and 1000-b sprayed from the spraying device 240 when the stage moves in the first direction overlap with second droplets 1010-a and 1010-b sprayed from the spraying device 240 when the stage moves in the second direction. That is, the second droplets 1010-a and 1010-b are shifted with respect to the first droplets 1000-a and 1000-b by the distance ‘d’ and the first droplets 1000-a and 1000-b and the second droplet 1010-a and 1010-b overlap one another. The distance between the droplets is controlled via adjusting the amount of shift ‘d’ in the third direction.

Even though the apparatus for manufacturing an organic layer according to the present embodiment of the invention may include a head unit having a smaller number of heads, it is just as effective in reducing the distance between drops as previous exemplary embodiments of the invention.

The transferring device 800 moves the stage 210 back and forth preferably two or three times to reduce the speed of manufacturing the organic layer.

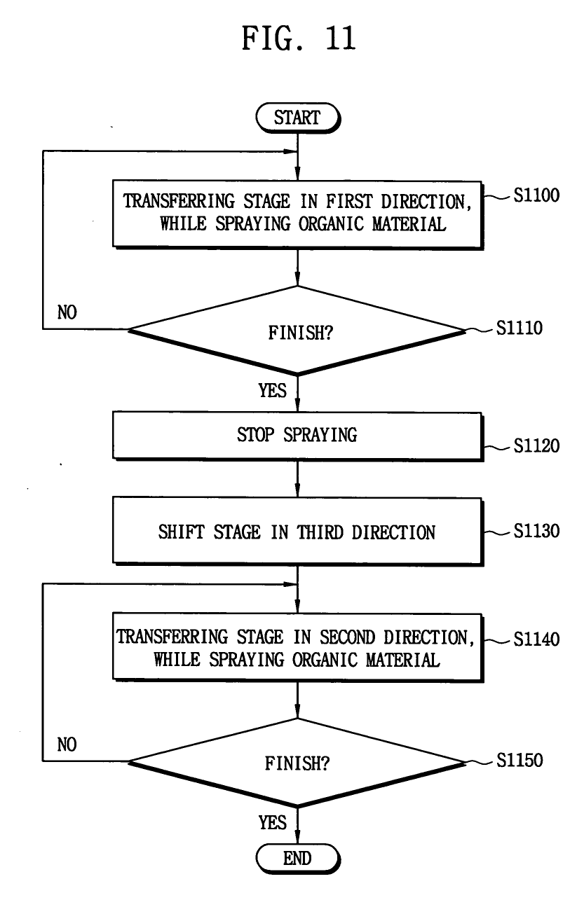

FIG. 11 is a flow chart of a method of forming an organic layer according to an exemplary embodiment of the present invention.

In step S 1100, the transferring device 800 transfers the stage 210 in the first direction, while the spraying device 240 sprays the organic material via the spraying nozzle.

In step S1110, it is determined whether transferring the stage 210 in the first direction is finished. If transferring in the first direction is finished, the process continues to step S1120 where the spraying device stops spraying the organic material.

In step S1130, the transferring device 800 is shifted in the third direction that is substantially perpendicular to the first direction by the distance ‘d’.

In step S1140, the transferring device 800 transfers the stage 210 in the second direction that is opposite to the first direction, while the spraying device 240 sprays the organic material via the spraying nozzle.

In step S1150, it is determined whether transferring the stage 210 in the second direction is finished. If transferring in the second direction is finished, the process ends.

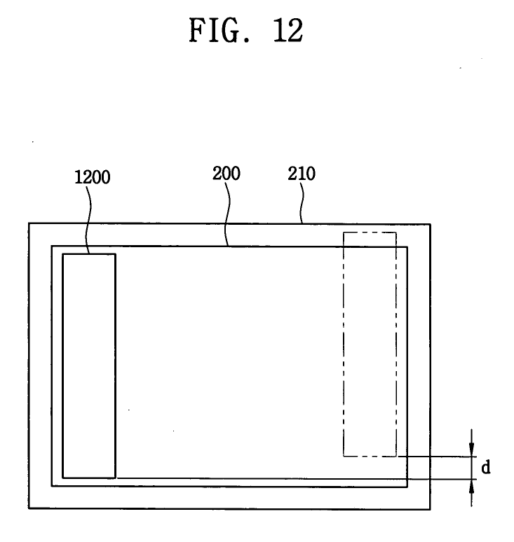

FIG. 12 is a schematic plan view of an apparatus for manufacturing an organic layer according to another exemplary embodiment of the present invention. The apparatus for manufacturing an organic layer according to the present embodiment of the invention is the same as previous exemplary embodiments of the present invention except for the spraying device. Thus, the same reference numerals will be used to refer to the same or like parts as those described in previous embodiments and any further explanation will be omitted.

The apparatus for manufacturing an organic layer according to the present exemplary embodiment of the invention includes a spraying device 1200. The spraying device 1200 may include a head unit having first to m-th heads or first to n-th head units.

When the a mother substrate 200 is disposed on a fixed stage 210, the spraying device 1200 moves in the first direction, while the spraying device 1200 sprays an organic material. When the spraying device 1200 reaches an end portion of the mother substrate 200, the spraying device 1200 stops spraying the organic material. Then, the spraying device 1200 is shifted by a distance ‘d’ in a third direction that is substantially perpendicular to the first direction. The spraying device 1200 moves again in the second direction that is opposite to the first direction, while spraying the organic material.

Droplets sprayed when the spraying device 1200 moves in the first direction and droplets sprayed when the spraying device 1200 moves in the second direction overlap with each other as shown in FIG. 10. Thus, a distance between the droplets is reduced. The distance between the droplets may be controlled via adjusting the shift distance ‘d’ of the spraying device 1200.

In a previous exemplary embodiment of the present invention, the stage moves while the spraying device is fixed. However, in the present embodiment of the invention, the spraying device moves while the stage is fixed.

Even though the apparatus for manufacturing an organic layer according to the present embodiment of the invention may include a head unit having a smaller number of heads, it is just as effective in reducing the distance between drops as previous exemplary embodiments of the invention.

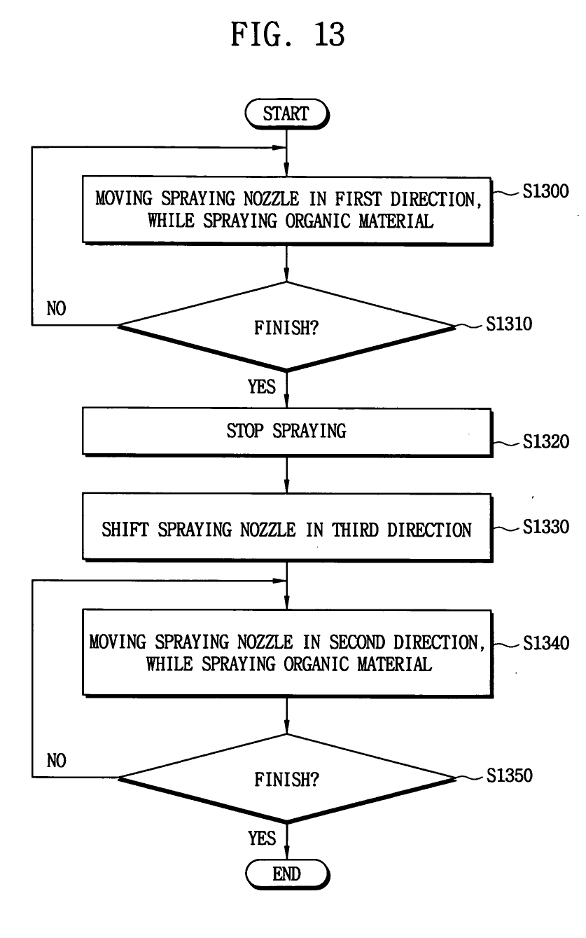

FIG. 13 is a flow chart showing a method of forming an organic layer according to another exemplary embodiment of the present invention.

In step S1300, the spraying device 1200 moves in the first direction, while the spraying device 1200 sprays the organic material via the spraying nozzle.

In step S1310, it is determined whether movement of the spraying device 1200 in the first direction is finished. If movement of the spraying device 1200 in the first direction is finished, the process continues to step S1320 where the spraying device 1200 stops spraying the organic material.

In step S1330, the spraying device 1200 is shifted in the third direction that is substantially perpendicular to the first direction by the distance ‘d’.

In step S1340, the spraying device 1200 moves in the second direction that is opposite to the first direction, while the spraying device 1200 sprays the organic material via the spraying nozzle.

In step S1350, it is determined whether movement of the spraying device 1200 in the second direction is finished. If movement of the spraying device 1200 is finished, the process ends.

The spraying device 1200 is moved back and forth across the mother substrate 200 preferably two or three times to reduce the speed of manufacturing the organic layer.

An apparatus for manufacturing an organic layer according to an exemplary embodiment of the present invention includes first to n-th head units. Each head unit is shifted by a distance ‘d’ from a previous head unit.

Thus, droplets of organic material, which are sprayed via the spraying nozzle of the first to n-th head units, overlap with each other to reduce a distance between the droplets.

An apparatus for manufacturing an organic layer according to another exemplary embodiment of the present invention includes a head unit that is inclined with respect to a side of a mother substrate, so that the distance between the droplets is reduced.

An apparatus for manufacturing an organic layer according to another embodiment of the invention includes a transferring device that transfers a stage in a first direction, shifts the stage in a third direction that is substantially perpendicular to the first direction, and transfers the stage in a second direction that is opposite to the first direction. Thus, the droplets sprayed while being transferred in the first direction and the droplets sprayed while being transferred in the second direction overlap with each other to reduce the distance between the droplets.

An apparatus for manufacturing an organic layer according to still another embodiment of the present invention includes a spraying device that moves in a first direction, moves in a third direction that is substantially perpendicular to the first direction, and moves again in a second direction that is opposite to the first direction. Thus, the droplets sprayed while moving in the first direction and the droplets sprayed while moving in the second direction overlap with each other to reduce the distance between the droplets.

While the present invention has been described in detail with reference to the preferred embodiments, those skilled in the art will appreciate that various modifications and substitutions can be made thereto without departing from the spirit and scope of the present invention as set forth in the appended claims.

1. An apparatus for forming an organic layer on a substrate, comprising:
a spraying device, the spraying device comprising:
a plurality of head units each formed in a corresponding row, wherein each head unit includes at least one head having spraying nozzles, and is shifted a horizontal distance from a previous head unit.

2. The apparatus of claim 1, wherein each head unit comprises a plurality of heads alternately disposed in first and second sub rows to form a zigzag pattern on the head unit.

3. The apparatus of claim 1, further comprising:
a stage that supports the substrate.

4. The apparatus of claim 1, further comprising:
a storage tank that stores organic material provided to the spraying device.

5. The apparatus of claim 1, wherein each head comprises a plurality of spraying nozzles.

6. The apparatus of claim 5, wherein each spraying nozzle comprises a piezoelectric element.

7. The apparatus of claim 1, wherein the spraying device forms an angle with respect to a side of the substrate.

8. The apparatus of claim 7, wherein the angle is in the range of about ±0° to about ±89°.

9. The apparatus of claim 3, further comprising a transferring device that transfers the stage in a first printing direction, a second printing direction that is opposite to the first printing direction, and a third direction that is substantially perpendicular to the first printing direction.

10. The apparatus of claim 9, wherein the spraying device is fixed.

11. The apparatus of claim 3, wherein the stage is fixed and the spraying device moves in a first printing direction, a second printing direction that is opposite to the first printing direction, and a third direction that is substantially perpendicular to the first printing direction.

12-18. (canceled)

19. An apparatus for forming an organic layer on a substrate, comprising:
a spraying device, the spraying device comprising a plurality of head units having a plurality of heads alternately disposed in first and second sub rows to form a zigzag pattern on the head unit, the heads having spraying nozzles arranged in a line.

20. The apparatus of claim 19, wherein each head unit is formed in a corresponding row, and is shifted a horizontal distance from a previous head unit.

21. The apparatus of claim 1, wherein the spraying nozzles are arranged in a line.

22. An apparatus for forming an organic layer on a substrate, comprising:
a spraying device that includes first to nth head units respectively disposed in first to nth rows, wherein n is an integer, and sprays organic material onto the substrate, each head unit being shifted by a distance from a previous head unit, wherein each head unit includes a plurality of heads having spraying nozzles; and
a transferring device that transfers the substrate in a printing direction.

23. The apparatus of claim 22, wherein the spraying nozzles are arranged in a line, and have a pitch between neighboring spraying nozzles.

24. The apparatus of claim 23, wherein a sum of the shift distances from the first row to the nth row is substantially identical to the pitch.

25. The apparatus of claim 22, wherein first heads of the plurality of heads are disposed in a first sub row and second heads of the plurality of heads are disposed in a second sub row, the first and second heads being alternately disposed to form a zigzag pattern on the head unit.

26. The apparatus of claim 25, wherein the first heads overlap with adjacent second heads to maintain a uniform distance between droplets of the organic material.

27. The apparatus of claim 22, wherein the spraying device forms an angle with respect to the side of the substrate.

28. The apparatus of claim 22, wherein the printing direction includes a first printing direction, a second printing direction that is opposite to the first printing direction, and a third direction that is substantially perpendicular to the first printing direction.
